(19) United States
(12) Patent Application Publication
(10) Pub. No.: US 2026/0121297 A1
(43) Pub. Date: Apr. 30, 2026

(54) High Gain Multiple Input, Multiple Output Antenna

(71) Applicant: TE Connectivity Solutions GmbH, Schaffhausen (CH)

(72) Inventors: KokJiunn NG, Penang (MY); Rizwan KHAN, Penang (MY); Jay Franklin GILLETTE, Middletown, PA (US); Youngha CHOI, Middletown, PA (US)

(73) Assignee: TE Connectivity Solutions GmbH, Schaffhausen (CH)

(21) Appl. No.: 18/925,151

(22) Filed: Oct. 24, 2024

(51) Int. Cl. H01Q 9/04; H01Q 1/48; H01Q 5/20; H01Q 5/48; H01Q 9/16

(52) U.S. Cl. CPC H01Q 9/0414; H01Q 1/48; H01Q 5/20; H01Q 5/48; H01Q 9/16

(57) ABSTRACT

A high gain multiple input, multiple output antenna which has a feeding board; a ground plane; a low band patch radiator; a first printed circuit board; a second printed circuit board; and a high band dipole patch radiator. The high band dipole patch radiator is a co-located stacked array on top of the low band patch radiator. The high band dipole patch radiator and the low band patch radiator are proximity coupled with the first printed circuit board and the second printed circuit board. The low band patch radiator covers low band frequencies in the range of 2.4 GHz to 2.5 GHZ and the high band dipole patch radiator cover high band frequencies in the range of 4.9 GHZ to 7.125 GHz. The antenna assembly has a gain of above 7.5 dBi and a well-directed radiation patten with no side lobes.

### FIELD OF THE INVENTION

The invention relates to a high gain multiple input, multiple output antenna.

### BACKGROUND OF THE INVENTION

Cellular communications systems are well known in the art. In a cellular communications system, a geographic area is often divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the ever-increasing volume of cellular communications, cellular operators have added cellular service in a variety of new frequency bands. While in some cases it is possible to use linear arrays of so-called “wide-band” or “ultra-wide band” radiating elements to provide service in multiple frequency bands, in other cases it is necessary to use different linear arrays (or planar arrays) of radiating elements to support service in the different frequency bands. As the number of frequency bands has proliferated, the number of base station antennas deployed at a typical base station has increased significantly. However, due to, for example, local zoning ordinances and/or weight and wind loading constraints for the antenna towers, there is often a limit as to the number of base station antennas that can be deployed at a given base station. In order to increase capacity without further increasing the number of base station antennas, so-called multi-band base station antennas have been introduced in recent years in which multiple linear arrays of radiating elements are included in a single antenna. Such multi-band base station antennas “low-band” radiating elements that are used to provide service in some or all of the 694-960 MHz frequency band and “high-band” radiating elements that are used to provide service in some or all of the 1695-2690 MHz frequency band.

A majority of the existing antenna achieve the dual-band characteristic by placing the two different resonating elements side by side to each other, which normally require a large space to accommodate both antennas. In such applications, the performance of the antenna can be affected by the close proximity of the antenna or resonating elements. As the elements are placed parasitically to each other for dual-band operation, additional Isolating element may be required to isolate the low band and high band antenna elements. In addition, the structure of such antennas can be complex, as the feeding network must be configured to accommodate the side by side configuration and must excite all elements for both low band and high band elements, thereby increasing the footprint and the cost of the antenna.

It would therefore be beneficial to provide to provide multi-band antenna which overcomes the disadvantages of the known art. In particular, it would be beneficial to provide an antenna in which the high-band radiators are stacked on the low-band radiator to minimize the footprint of the antenna and which has well-directed radiation patten.

### SUMMARY OF THE INVENTION

The following provides a summary of certain illustrative embodiments of the present invention. This summary is not an extensive overview and is not intended to identify key or critical aspects or elements of the present invention or to delineate its scope.

An object is to provide a high gain +/−45 degree slant antenna which has a gain above 7.5 dBi with a well-directed radiation pattern across the frequency bands, such as but not limited to, 2.4 GHz to 2.5 GHz and 4.9 GHZ to 7.125 GH).

An object is to provide an antenna which is compact and can easily fit into the required housing and which has a relatively simple structure, wider resonance bandwidth in a radiation frequency band, stable gain and directional radiation pattern, lower cross-polarization, higher port isolation as well as low cost.

An object is to provide a high gain slant antenna which can realize triband operation without extra installation space.

An embodiment is directed to a high gain multiple input, multiple output antenna which has a feeding board; a ground plane; a low band patch radiator; a first printed circuit board; a second printed circuit board; and a high band dipole patch radiator. The high band dipole patch radiator and the low band patch radiator form a co-located stacked patch antenna. The high band dipole patch radiator and the low band patch radiator are proximity coupled with the first printed circuit board and the second printed circuit board.

The low band patch radiator covers low band frequencies in the range of 2.4 GHz to 2.5 GHZ and the high band dipole patch radiator cover high band frequencies in the range of 4.9 GHZ to 7.125 GHz. The antenna assembly has a gain of above 7.5 dBi and a well-directed radiation patten with no side lobes

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 a perspective view of an illustrative embodiment of an antenna assembly according to the present invention, a ground plane is shown as translucent to better shown all of the components.

FIG. 2 is an exploded perspective view of the antenna assembly of FIG. 1.

FIG. 3 is a planar view of a feeding board of the antenna assembly of FIG. 1.

FIG. 4 is a planar view of a circular patch antenna positioned on a rectangular ground plane of the antenna assembly of FIG. 1, the circular patch antenna having two crossed slots for receipt of two vertical printed circuit boards therein.

FIG. 5 is a planar view of a first surface of a first vertical printed circuit board which is inserted into a first crossed slot of FIG. 4.

FIG. 6 is a planar view of a second surface of the first vertical printed circuit board of FIG. 5.

FIG. 7 is a planar view of a first surface of a second vertical printed circuit board which is inserted into a second crossed slot of FIG. 4.

FIG. 8 is a planar view of a second surface of a second vertical printed circuit board of FIG. 7.

FIG. 9 is a planar view of a high band dipole patch array assembly of FIG. 1.

FIG. 10 is a perspective view of an illustrative housing with two illustrative antenna assemblies positioned therein.

FIG. 11 is a graph illustrating the Voltage Standing Wave Ratio (VSWR) v. the low band frequency of the ports of the antenna assemblies of FIG. 10.

FIG. 12 is a graph illustrating the VSWR v. the high band frequency of the ports of the antenna assemblies of FIG. 10.

FIG. 13 is a graph illustrating the isolation between the low band frequency of the ports of the antenna assemblies of FIG. 10.

FIG. 14 is a graph illustrating the isolation between the high band frequency of the ports of the antenna assemblies of FIG. 10.

FIG. 15 is a graph illustrating the maximum gain v. the low band frequency of the ports of the antenna assemblies of FIG. 10.

FIG. 16 is a graph illustrating the maximum v. the high band frequency of the ports of the antenna assemblies of FIG. 10.

FIG. 17 is a graph illustrating the efficiency v. the low band frequency of the ports of the antenna assemblies of FIG. 10.

FIG. 18 is a graph illustrating the efficiency v. the high band frequency of the ports of the antenna assemblies of FIG. 10.

FIG. 19 is a graph illustrating the beamwidth 3 dB Phi (0) v. the low band frequency of the ports of the antenna assemblies of FIG. 10.

FIG. 20 is a graph illustrating the beamwidth 3 dB Phi (0) v. the high band frequency of the ports of the antenna assemblies of FIG. 10.

FIG. 21 is a graph illustrating the beamwidth 3 dB Phi (90) v. the low band frequency of the ports of the antenna assemblies of FIG. 10.

FIG. 22 is a graph illustrating the beamwidth 3 dB Phi (90) v. the high band frequency of the ports of the antenna assemblies of FIG. 10.

FIGS. 23A, 23B and 23C are illustrative radiation patterns at EI Plane 1 (Phi 0) for port 1 of FIG. 10 at various frequencies.

FIGS. 24A, 24B and 24C are illustrative radiation patterns at EI Plane 2 (Phi 90) for port 1 of FIG. 10 at various frequencies.

FIGS. 25A, 25B and 25C are illustrative radiation patterns at EI Plane 1 (Phi 0) for port 2 of FIG. 10 at various frequencies.

FIGS. 26A, 26B and 26C are illustrative radiation patterns at EI Plane 2 (Phi 90) for port 2 of FIG. 10 at various frequencies.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

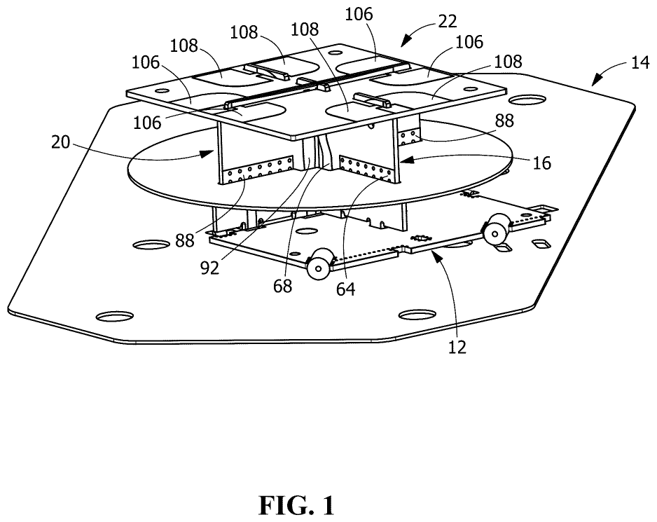

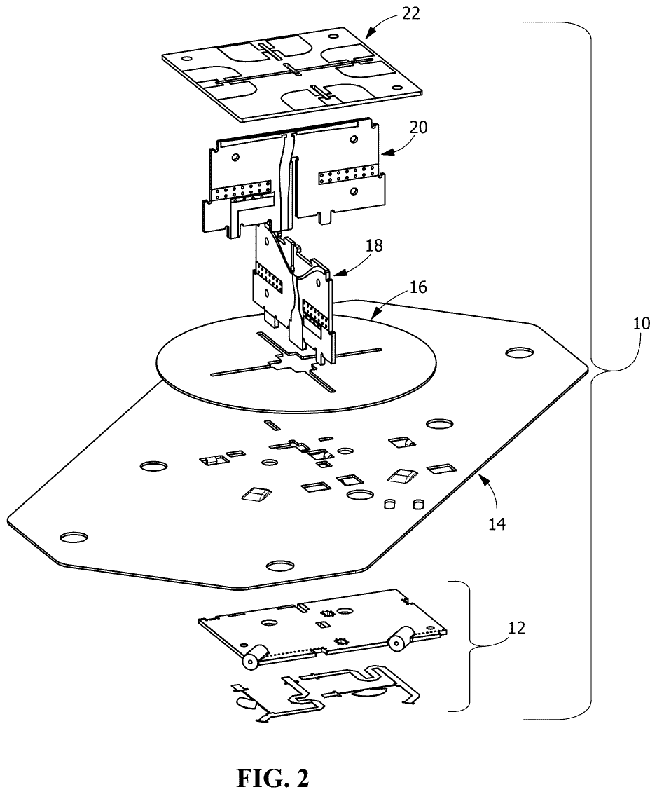

An illustrative embodiment of a high gain multiple input, multiple output antenna assembly 10 of the present invention is shown in FIGS. 1 and 2. The illustrative embodiment depicts a tri-band directional antenna. The antenna assembly 10 includes a feeding board 12, a ground plane 14, a low band patch radiator or antenna 16, a first substrate or printed circuit board 18, a second substrate or printed circuit board 20, and a high band dipole patch radiator or antenna 22.

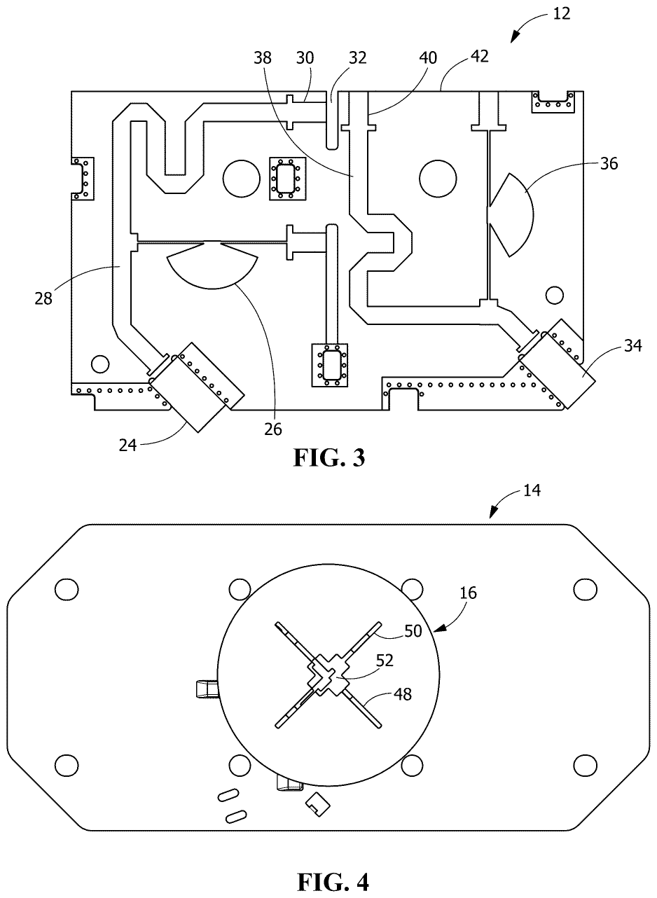

As shown in FIG. 3, the feeding board 12 has a first port 24 which is electrically connected to a first low pass filter 26 and a first feeding trace or network 28. An end 30 of the first trace 28 is positioned adjacent to a mounting slot 32. The feeding board 12 has a second port 34 which is electrically connected to a second low pass filter 36 and a second feeding trace or network 38. An end 40 of the second trace 28 is positioned adjacent to a mounting edge 42. As only low pass filters are used, the size of the feeding board 12 can be small. The phase of the traces 28, 38 are optimized to combine both the low band and the high band without the need of a high pass filter.

The ground plane 14, as shown in the illustrative embodiment of FIG. 4 has a rectangular configuration. The rectangular configuration allows for gain enhancement for the low band antenna as compared to a square ground plane. In the illustrative embodiment shown the ground plane 14 dimension is approximately 186 mm by approximately 79 mm, but other dimensions may be used depending upon the configuration of the antenna assembly. In the illustrative embodiment, the ground plane size is optimized to achieve the desired goal of gain for low band of 7.5 dbi. However, the ground plane 14 may have different sizes/shapes to accommodate different gain requirements.

In the illustrative embodiment shown in FIG. 4, the low band patch radiator or antenna 16 is a circular metal member with crossed circuit board receiving slots 48, 47 for receiving the first printed circuit board 18 and the second printed circuit board 20 therein. The slots 48, 47 converge to form a larger center opening 52. The low band patch radiator or antenna 16 is for the low band frequencies of 2.4 GHz to 2.5 GHZ. In the illustrative embodiment shown the low band patch radiator or antenna 16 has a diameter of approximately 58 mm, but other dimensions may be used depending upon the configuration of the antenna assembly.

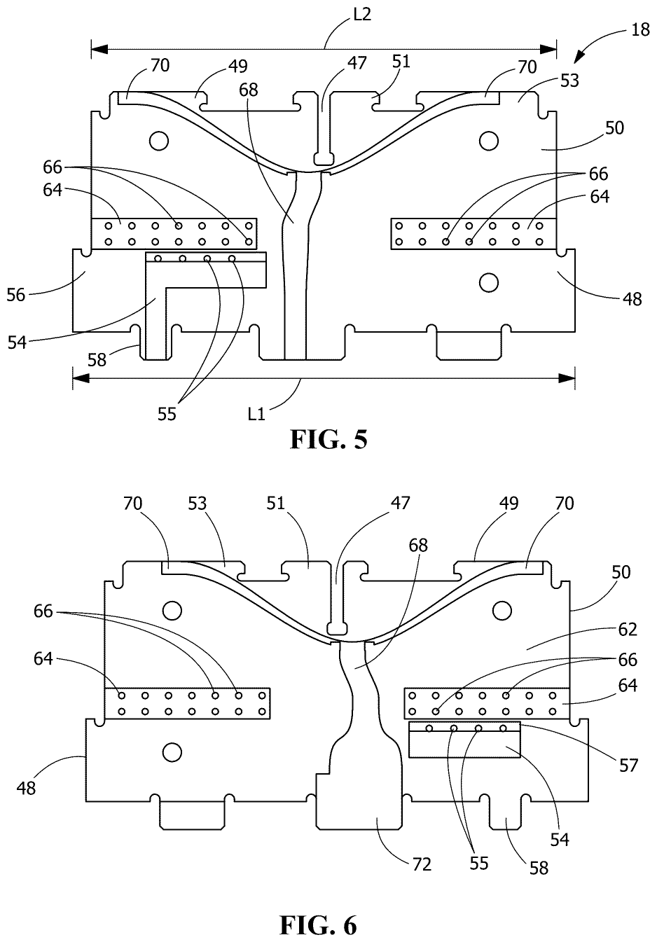

The first substrate or printed circuit board 18 extends in a plane which is essentially perpendicular to a plane of the low band patch radiator or antenna 16. In the illustrative embodiment shown in FIGS. 5 and 6, the first substrate or printed circuit board 18 is a vertical substrate. The first substrate 18 has a first section 48 and a second section 50, which extends from the first section 48. The first section 48 has a length L1 which is greater than a length L2 of the second section 50. When assembled, the first section 48 is positioned below the low band patch radiator or antenna 16, as viewed in FIG. 1.

A slot 52 is provided in the second section 50. The slot 52 extends from a top end of the second section 50 toward the first section 48. Mounting tabs 49, 51, 53 extend from the top end of the second section 50 in a direction away from the first section 48.

The first printed circuit board 18 has a first inverted L-probe 54 which is provided on a first surface 56 of the first printed circuit board 18 in the first section 48. The probe is configured to make an electrical connection with the low band patch radiator or antenna 16. The probe 54 extends to a mounting projection 58 which extends from a bottom end of the first section 48 in a direction away from the second section 50.

Metallic vias or plated through holes 55 are provided between the L-probe 54 and a copper trace 57 on a second surface 62 of the first printed circuit board 18. The vias 55 improve the coupling to the low band patch radiator or antenna 16 and also improve the bandwidth at low band frequencies.

The first printed circuit board 18 has solder pads 64 positioned on both the first surface 56 and the second surface 62 proximate the probe 54. The solder pads 64 are connected through the first printed circuit board 18 by metallic vias 66. The solder pads 64 are utilized to solder the circular low band patch radiator or antenna 16 to the first printed circuit board 18. This solder connection closes the slot 48 in the circular low band patch radiator or antenna 16 to prevent unwanted frequencies from radiating through the antenna assembly 10.

The first printed circuit board 18 has a center differential feed 68 with a corporate line. The center feed 68 electrically connects the second port 34 of the feeding board 12 to the high band dipole patch radiator or antenna 22. The center differential feed 68 is optimized to achieve a wider bandwidth from 4.9 GHZ to 7.125 GHz. The center differential feed 68 is slightly misaligned or offset to allow for the positioning of the slot 52. A ground port 72 is provided at the end of the center differential feed 68. The bottom of the center differential feed 68 is positioned in the mounting slot 32 and is soldered to the feeding board 12. Ends 70 of the center differential feed 68 extend into the mounting tabs 49, 53. In the illustrative embodiment shown, the center differential feed 68 has a Y configuration when viewed in FIGS. 5 and 6.

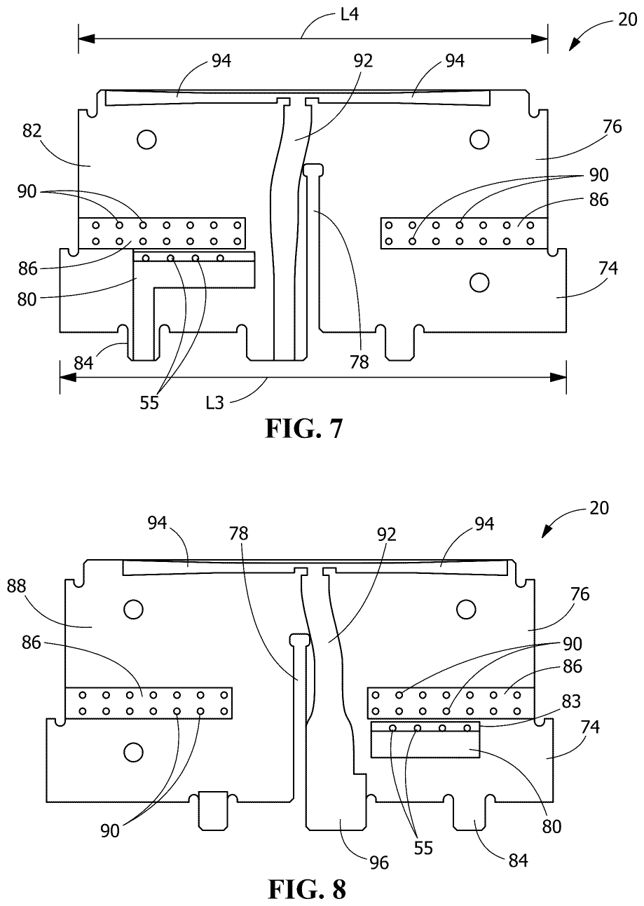

The second substrate or printed circuit board 20 extends in a plane which is essentially perpendicular to a plane of the low band patch radiator or antenna 16. In the illustrative embodiment shown in FIGS. 7 and 8, the second substrate or printed circuit board 20 is a vertical substrate. The second substrate 20 has a first section 74 and a second section 76, which extends from the first section 74. The first section 74 has a length L3 which is greater than a length L4 of the second section 76. In the embodiment shown, the length L3 is equal to the length L1 and the length L4 is equal to the length L2. When assembled, the first section 74 is positioned below the low band patch radiator or antenna 16, as viewed in FIG. 1. A slot 78 is provided which extends from the first section 74 into the second section 76.

The second printed circuit board 20 has a first inverted L-probe 80 which is provided on a first surface 82 of the second printed circuit board 20 in the first section 74. The probe 80 is configured to make an electrical connection with the low band patch radiator or antenna 16. The probe 80 extends to a mounting projection 84 which extends from a bottom end of the first section 74 in a direction away from the second section 76.

Metallic vias or plated through holes 81 are provided between the L-probe 80 and a copper trace 83 on a second surface 88 of the second printed circuit board 20. The vias 81 improve the coupling to the low band patch radiator or antenna 16 and also improve the bandwidth at low band frequencies.

The second printed circuit board 20 has solder pads 86 positioned on both the first surface 82 and the second surface 88. The solder pads 86 are connected through the second printed circuit board 20 by metallic vias 90. The solder pads 86 are utilized to solder the circular low band patch radiator or antenna 16 to the second printed circuit board 20. This solder connection closes the slot 47 in the circular low band patch radiator or antenna 16 to prevent unwanted frequencies from radiating through the antenna assembly 10.

The second printed circuit board 20 has a center differential feed 92 with a corporate line. The center differential feed 92 electrically connects the feeding board 12 to the high band dipole patch radiator or antenna 22. The center differential feed 92 is optimized to achieve a wider bandwidth from 4.9 GHZ to 7.125 GHz. The center differential feed 92 is slightly misaligned or offset to allow for the positioning of the slot 78. A ground port 96 is provided at the end of the center differential feed 92. The bottom of the center differential feed 92 is positioned proximate the mounting slot 32 and is soldered to the feeding board 12. Ends 94 of the center differential feed 92 are proximate to and essentially parallel to the top end of the second printed circuit board 20. In the illustrative embodiment shown, the center differential feed 92 has a T configuration when viewed in FIGS. 7 and 8.

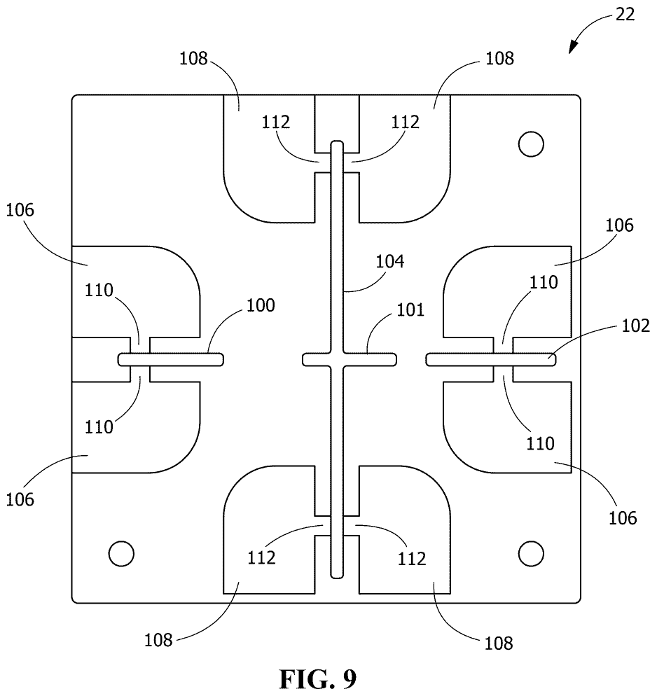

An illustrative embodiment of the high band dipole patch radiator or antenna 22 is shown in FIG. 9. The high band dipole patch radiator or antenna 22 has mounting slots 100, 101, 102 which are dimensioned to receive the mounting tabs 49, 51, 53 of the first substrate or printed circuit board 18 therein. The high band dipole patch radiator or antenna 22 also has a mounting slot 104 which is dimensioned to receive the top end of the second substrate or printed circuit board 20 therein. An axis of the mounting slot 102 is essentially perpendicular to an axis of the mounting slots 100, 101, 102. As shown in FIG. 1, the mounting tabs 49, 51, 53 of the first substrate or printed circuit board 18 are positioned in the mounting slots 100, 101, 102 and the top end of the second substrate or printed circuit board 20 is positioned in the mounting slot 104. The high band dipole patch radiator or antenna 22 is retained in position relative to the first substrate or printed circuit board 18 and the second substrate or printed circuit board 20 by solder.

Dipole assemblies 106, 108 are provided on the high band dipole patch radiator or antenna 22. Dipole assemblies 106 have engagement sections 110 which extend to the slots 100, 102. With the first substrate or printed circuit board 18 properly positioned, the ends 69, 71 are provided in electrical engagement with the engagement sections 110, thereby providing an electrical pathway between the first port 24 and the dipole assemblies 106. Dipole assemblies 108 have engagement sections 112 which extend to the slot 104. With the second substrate or printed circuit board 20 properly positioned, the ends 93, 94 are provided in electrical engagement with the engagement sections 112, thereby providing an electrical pathway between the second port 34 and the dipole assemblies 108.

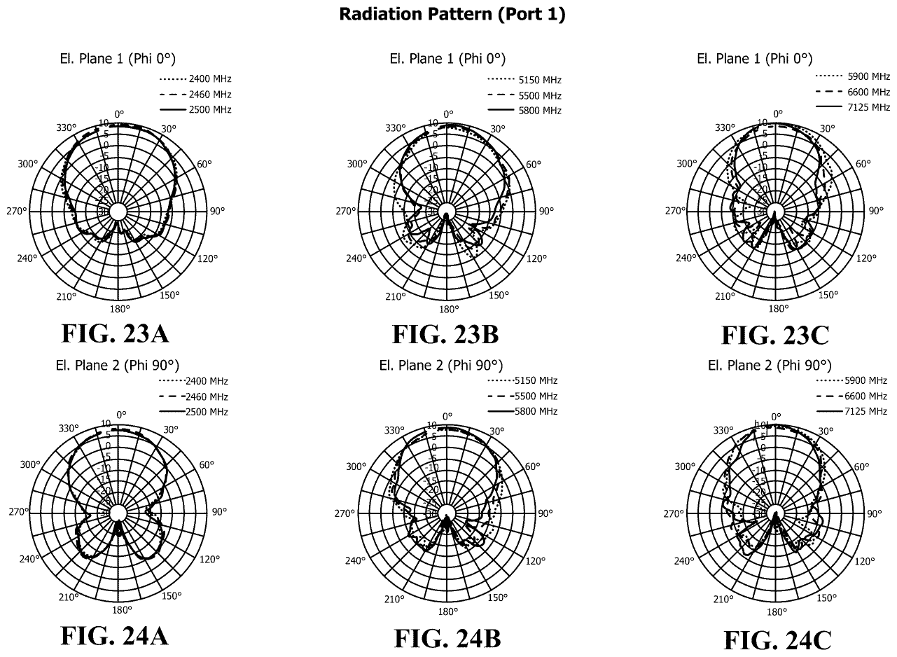

The high gain multiple input, multiple output antenna assembly 10 has dual radiating elements to cover low band frequencies in the range of 2.4 GHz to 2.5 GHZ and high band frequencies in the range of 4.9 GHZ to 7.125 GHZ. For the high band, a differential feed with a corporate line is utilized to excite the two-element array for both polarizations (±45°). The low band resonance is achieved by the low band circular patch radiator or antenna 16 which is parasitically fed by two ±45° inverted L-shaped probes 54, 80. The antenna assembly 10 has a well-directed radiation patten with no side lobes, as shown in FIGS. 23A, 23B, 23C, 24A, 24B, 24C, 25A, 25B, 25C, 26A, 26B and 26C.

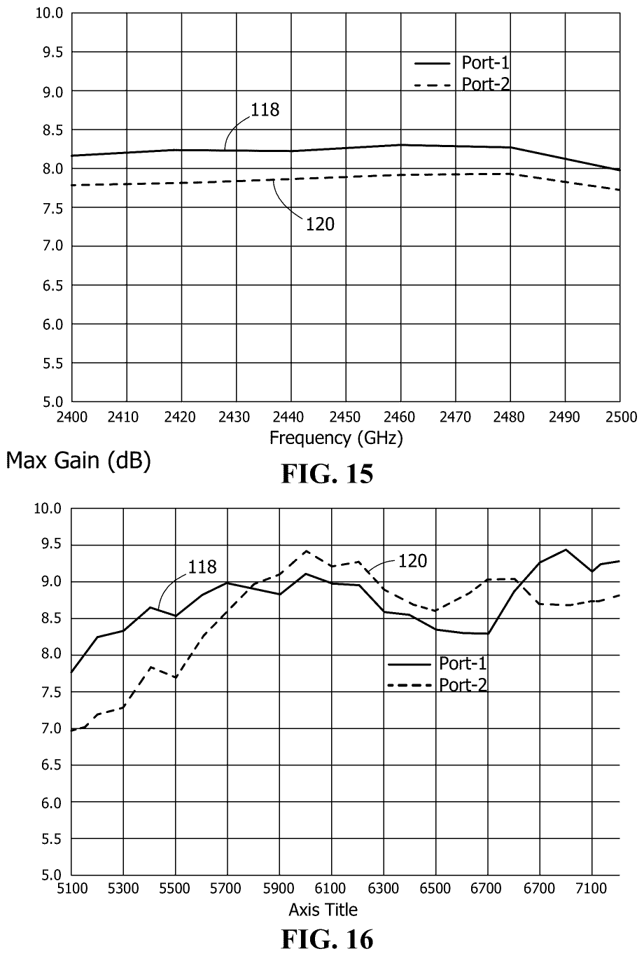

The antenna has a high gain (gain above 7.5 dBi) across the band with low gain variation between the low band and the high band, as shown in FIGS. 15 and 16. The high band dipole patch radiator or antenna 22 compensates for losses from the cable loss to achieve similar gain for the high band. The configuration of the ground plane 14 influences the low band gain to ensure sufficient gain with narrower elevation beamwidth.

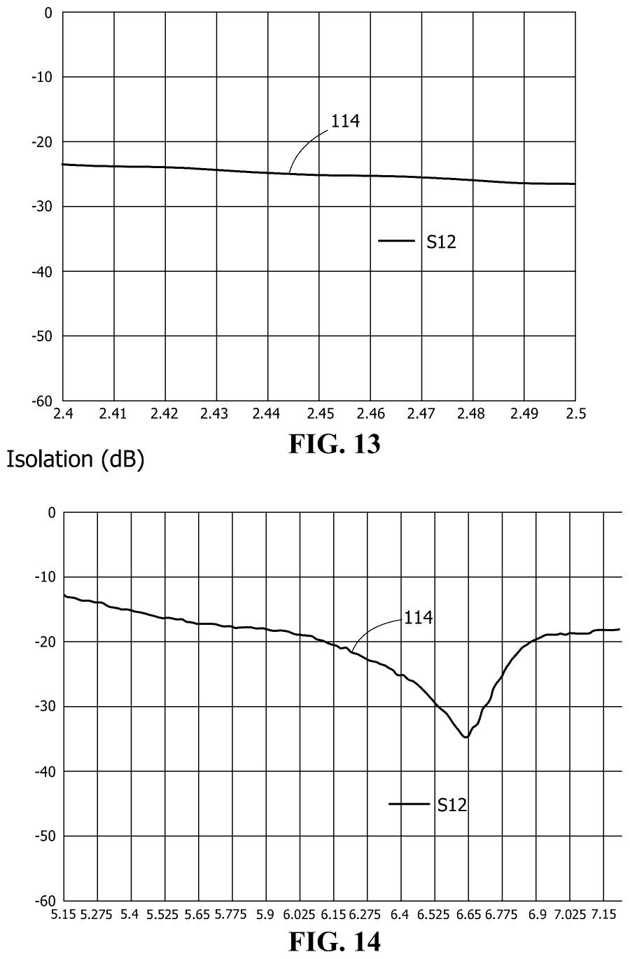

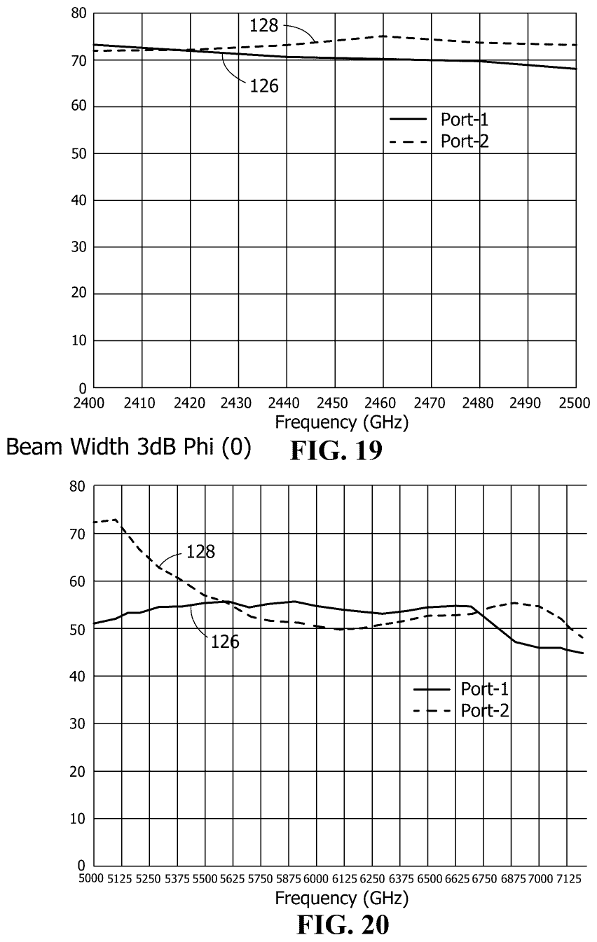

The antenna exhibits better than 20 dB isolation across all the bands, as shown in FIGS. 13 and 14. The beamwidth of the radiation pattern in azimuth and elevation plane also shows quite consistent performance across a wide range of frequencies, as is shown in FIGS. 19 through 22.

In the illustrative embodiment shown, the antenna assembly 10 has a height of 25 mm, allowing the antenna assembly 10 to fit into the compact spaces, radomes or housings. The high band dipole patch radiator or antenna 22 is a co-located stacked array on top of the low band patch radiator or antenna 16, proximity coupled with the two vertical printed circuit boards 18, 20 having dual slant inverted L-probes 54, 80. The high band dipole patch radiator or antenna 22 and the low band patch radiator antenna 16 form a stacked patch antenna.

As previously stated, the frequency range covered if the antenna assembly 10 is 2.4-2.5 Ghz and 5.15-7.125 GHZ, which is a triband in the application of WiFi 6 and 7. In order to achieve the tri-band structure, the circular-shaped metallic radiator or antenna 16 is supplied for the low band and the squared-shaped dipole radiator or antenna 22 is utilized for the high band. The high-band radiators are stacked up on the low-band radiators, with the low band radiator or antenna 16 having two crossed probes 54, 80 and the high band radiator or antenna 22 having two crossed 2×2 dipole assemblies 106, 108 to achieve ±45° polarization. The lower circular-shaped metallic radiator or antenna 16 is excited parasitically by the L-shaped probes 54, 80 whereas for the high band radiator or antenna 22, a differential feed line (twin line) 68, 70, 92, 94 is by the two vertical printed circuit boards 18, 20 for separate polarization.

In the illustrative embodiment, the circular low band radiator or antenna 16 is adopted for low band and provides a peak gain of 8.3 dBi with a beamwidth of approximately 71° in the Azimuth plane and 54° in the elevation plane, whereas the microstrip planar high band radiator or antenna 22 is utilized for high bands and provides a peak gain of 9.1 dBi gain and approximately 58° Azimuth and 67° Elevation beamwidth for a band between 5.15 MHz to 5950 MHz and 9.1 dBi gain and approximately 53° Azimuth and 51° Elevation beamwidth for band between 6000 MHz to 7125 MHz.

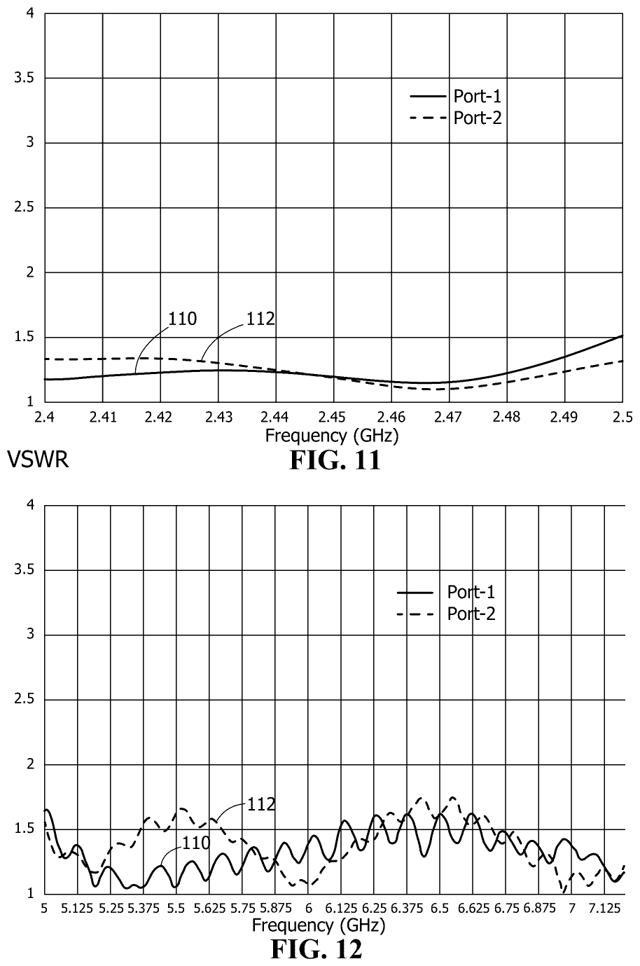

The electrical parameters and radiation patterns of the illustrative antenna assembly 10 are shown in FIGS. 11 through 22 and as follows:

| Antenna type | Directional | |
|---|---|---|
| Frequency Range | Tri-Band (2.4 GHz + 5 GHz-7.15 GHz) | |
| Impedance | 50 | Ω |
| VSWR | <2.0 | |
| Isolation to another | <20 | dB |
| antenna element | | |
| Efficiency % (Average) 2.4G | >70 | |
| Efficiency %(Average) 5G | >65 | |
| Efficiency % (Average) 6G | >60 | |
| Max Power | 33 | dBm |
| Polarization | ±45°/±135° | |
| Cross polarization Ratio | 9:1 | |
| Max Gain 2.4G | 8.3 | dBi |
| Max Gain 5G | 9.1 | dBi |
| Max Gain 6G | 9.3 | dBi |
| Port isolation | 20 | dB |

| | |
|---|---|
| Pattern E plane, H-plane 2.4G | Average (Az = 71° & El = 54°) |
| Pattern E plane, H-plane 5G | Average (Az = 58° & El = 64°) |
| Pattern E plane, H-plane 6G | Average (Az = 53° & El = 51°) |

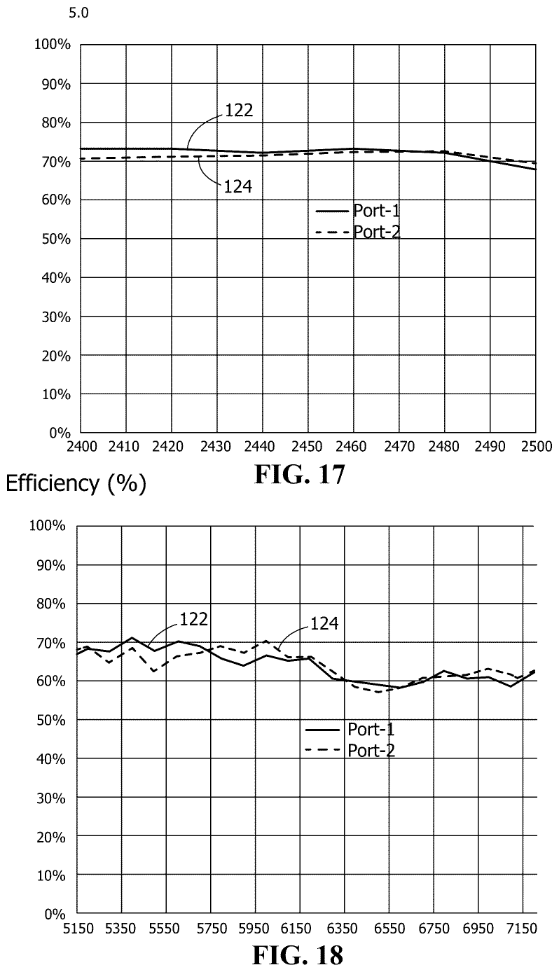

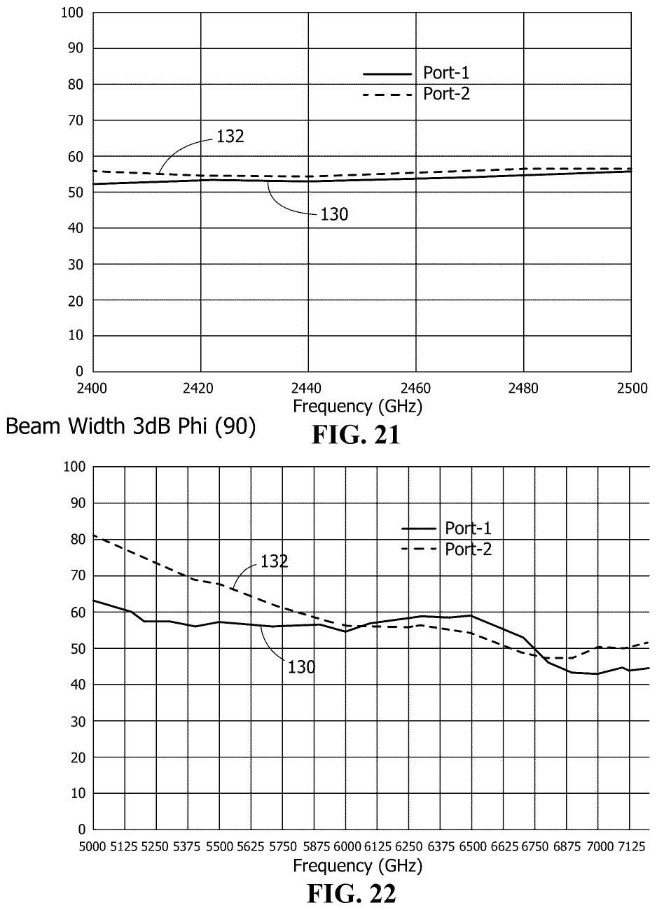

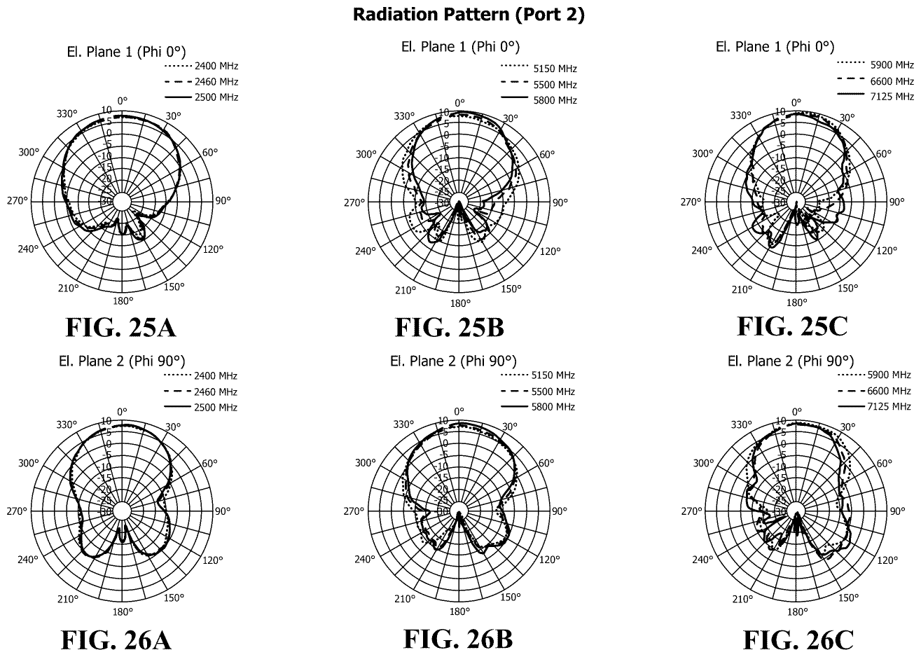

FIGS. 11 and 12 graph the voltage standing wave ratio v. frequency for port 1 (110) and port 2 (112). FIGS. 13 and 14 graph the isolation v. frequency between port 1 and port 2 (114). FIGS. 15 and 16 graph the maximum gain v. frequency for port 1 (118) and port 2 (120). FIGS. 17 and 18 graph the efficiency v. frequency for port 1 (122) and port 2 (124). FIGS. 19 and 20 graph the beamwidth 3 dB Phi (0 degrees) v. frequency for port 1 (126) and port 2 (128). FIGS. 21 and 22 graph the beamwidth 3 dB Phi (90 degrees) v. frequency for port 1 (130) and port 2 (132). FIGS. 23A, 23B, 23C illustrate the radiation pattern of port 1 in the El. Plane (Phi 0 degrees) at various frequencies. FIGS. 24A, 24B, 24C illustrate the radiation pattern of port 1 in the El. Plane (Phi 90 degrees) at various frequencies. FIGS. 25A, 25B, 25C illustrate the radiation pattern of port 2 in the El. Plane (Phi 0 degrees) at various frequencies. FIGS. 26A, 26B, 26C illustrate the radiation pattern of port 2 in the El. Plane (Phi 90 degrees) at various frequencies.

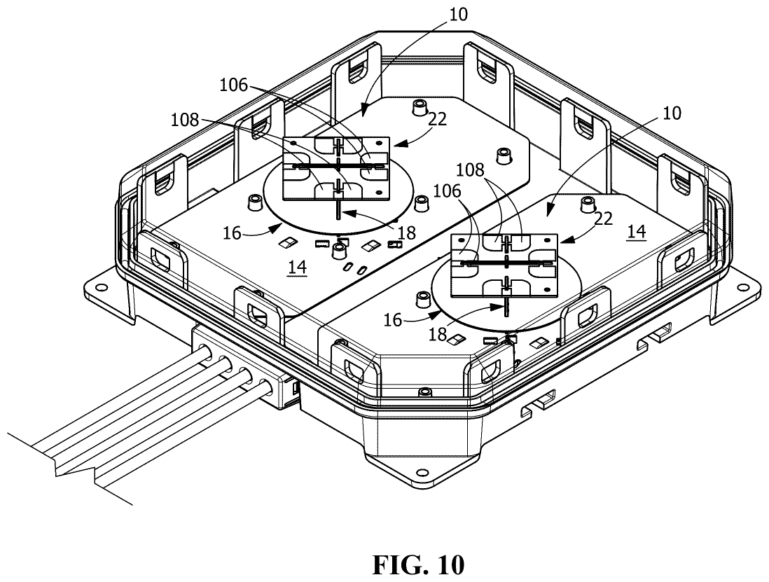

The antenna assembly 10 may be used for multiple applications, such as, but not limited to, base-station applications, due to its steady structure and high scalability. For example, FIG. 10 shown the two antenna assemblies 10 being used in a 4×4 MIMO configuration with 4 ports. However, the antenna assembly may be used in other configurations, including, but not limited to, an 8 ×8 configuration.

This antenna assembly 10 is a high gain +/−45 degree slant antenna which has a gain above 7.5 dBi with a well-directed radiation pattern across the frequency bands 2.4 GHz to 2.5 GHz and 4.9 GHz to 7.125 GHz. The antenna assembly 10 is compact and can easily fit into a required housing. The antenna assembly 10 has: a relatively simple structure; wider resonance bandwidth in a radiation frequency band; stable gain and directional radiation pattern; lower cross-polarization, higher port isolation; and low cost. The antenna assembly 10 can realize triband operation without extra installation space.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. A high gain multiple input, multiple output antenna comprising:
a feeding board;
a ground plane;
a low band patch radiator;
a first printed circuit board;
a second printed circuit board; and
a high band dipole patch radiator;
wherein the high band dipole patch radiator and the low band patch radiator form a stacked patch antenna; and
wherein the high band dipole patch radiator and the low band patch radiator are proximity coupled with the first printed circuit board and the second printed circuit board.

2. The high gain multiple input, multiple output antenna as recited in claim 1, wherein the low band patch radiator covers low band frequencies in the range of 2.4 GHz to 2.5 GHz and the high band dipole patch radiator cover high band frequencies in the range of 4.9 GHz to 7.125 GHz.

3. The high gain multiple input, multiple output antenna as recited in claim 1, wherein the antenna assembly has a gain of above 7.5 dBi and a well-directed radiation patten with no side lobes.

4. The high gain multiple input, multiple output antenna as recited in claim 1, wherein the feeding board has a first port which is electrically connected to a first low pass filter and a first feeding trace or network, and a second port which is electrically connected to a second low pass filter and a second feeding trace or network.

5. The high gain multiple input, multiple output antenna as recited in claim 1, wherein the ground plane has a rectangular configuration.

6. The high gain multiple input, multiple output antenna as recited in claim 1, wherein the low band patch radiator is a circular member with crossed circuit board receiving slots for receiving the first printed circuit board and the second printed circuit board therein.

7. The high gain multiple input, multiple output antenna as recited in claim 6, wherein the low band patch radiator is for low band frequencies in the range of approximately 2.4 GHz to approximately 2.5 GHZ.

8. The high gain multiple input, multiple output antenna as recited in claim 7, wherein the first printed circuit board and the second printed circuit board extend in a planes which are essentially perpendicular to a plane of the low band patch radiator.

9. The high gain multiple input, multiple output antenna as recited in claim 8, wherein the first printed circuit board and the second printed circuit board have first sections and second sections, the second sections extend from the first sections, the first sections have first lengths which are greater than second lengths of the second sections, the first sections are positioned below the low band patch radiator.

10. The high gain multiple input, multiple output antenna as recited in claim 8, wherein the first printed circuit board and the second printed circuit board have inverted L-probes which are provided in the first sections, the probes make electrical connection with the low band patch radiator.

11. The high gain multiple input, multiple output antenna as recited in claim 10, wherein the first printed circuit board and the second printed circuit board have solder pads positioned proximate the probes, the solder pads close the slots in the low band patch radiator to prevent unwanted frequencies from radiating through the antenna assembly.

12. The high gain multiple input, multiple output antenna as recited in claim 10, wherein the first printed circuit board and the second printed circuit board have center differential feeds with a corporate line, the differential feeds electrically connect the feeding board to the high band dipole patch radiator, the differential feeds are for high band frequencies in the range of approximately 4.9 GHZ to approximately 7.125 GHZ.

13. The high gain multiple input, multiple output antenna as recited in claim 12, wherein a first slot is provided in the second section of the first printed circuit board, the first slot extends from a top end of the second section of the first printed circuit board toward the first section of the first printed circuit board.

14. The high gain multiple input, multiple output antenna as recited in claim 13, wherein a second slot is provided in the second printed circuit board, the second slot extends from the first section of the second printed circuit board into the second section of the second printed circuit board.

15. The high gain multiple input, multiple output antenna as recited in claim 14, wherein the differential feeds are offset to allow for the positioning of the first slot in the first printed circuit board and the second slot in the second printed circuit board.

16. The high gain multiple input, multiple output antenna as recited in claim 12, wherein the center differential feed of the first printed circuit board has a Y configuration.

17. The high gain multiple input, multiple output antenna as recited in claim 16, wherein the center differential feed of the second printed circuit board has a T configuration.

18. The high gain multiple input, multiple output antenna as recited in claim 12, wherein the high band dipole patch radiator has one or more first mounting slots which are dimensioned to receive the first printed circuit board and one or more second mounting slots which are dimensioned to receive the second printed circuit board.

19. The high gain multiple input, multiple output antenna as recited in claim 18, wherein an axis of the one or more first mounting slot is essentially perpendicular to an axis of the one or more second mounting slots.

20. The high gain multiple input, multiple output antenna as recited in claim 12, wherein the high band dipole patch radiator has first dipole assemblies and second dipole assemblies provided thereon, the first dipole assemblies provided in electrical engagement with the center differential feed of the first printed circuit board and the second dipole assemblies provided in electrical engagement with the center differential feed of the second printed circuit board.
